(19) United States
(12) Patent Application Publication
(10) Pub. No.: US 2004/0043301 A1
(43) Pub. Date: Mar. 4, 2004

(54) Data storage medium and data storage apparatus

(76) Inventors: Akiko Hirao, Chiba-shi (JP); Kazuki Matsumoto, Kawasaki-shi (JP); Takayuki Tsukamoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/642,226

(22) Filed: Aug. 18, 2003

(30) Foreign Application Priority Data
Aug. 29, 2002 (JP) 2002-251406

(51) Int. Cl. G03C 1/00; G03H 1/02

(52) U.S. Cl. 430/2; 359/3

(57) ABSTRACT

Disclosed is a data storage medium, comprising a recording layer containing molecules having a charge transport characteristics, molecules having a nonlinear optical characteristics, and optical functional molecules whose stereostructure is changed depending on a light irradiation, and a pair of transparent ohmic electrodes sandwiching the recording layer. The conductivity of the data storage medium is lowered by the light irradiation.

### CROSS-REFERENCE TO RELATED APPLICATIONS

This application is based upon and claims the benefit of priority from the prior Japanese Patent Application No. 2002-251406, filed Aug. 29, 2002, the entire contents of which are incorporated herein by reference.

### BACKGROUND OF THE INVENTION

1. Field of the Invention

The present invention relates to a data storage medium, particularly, a data storage medium into which electrons are injected through an electrode, the data storage medium having the electrons trapped thereinto being irradiated with two light beams capable of interference so as to form a space charge distribution, thereby performing the data storage, and to a data storage apparatus for recording the data in the particular data storage medium.

2. Description of the Related Art

A photorefractive medium is known as a recording medium capable of achieving data storage at a density markedly higher than that of a photomagnetic disk or an optical disk.

The photorefractive medium is a medium exhibiting the photorefractive effect. Also, the term “photorefractive effect” denotes the effect that the charges generated by the light irradiation are rearranged by the diffusion so as to cause the refractive index to be changed by the generated electric field. It follows that it is necessary for the material exhibiting the photorefractive effect to exhibit both photoconductivity and the electrooptical characteristics.

The following description covers the case where a photorefractive medium is used as a recording medium of a holographic memory. If a photorefractive medium is irradiated with an object light and with a reference light, an interference fringe is formed by these two light beams, and positive and negative charges are generated in the same number in each region of the recording medium in accordance with the intensity of the light. The number of conjugated electrons of the charge transport molecule used in the case of the molecularly doped polymer is smaller than that of an electrically conductive high molecular weight compound such as polyacetylene, and the charge transport molecule noted above has a molecular weight lower than that of the electrically conductive high molecular weight compound noted above. It follows that the Coulomb energy in the case of injecting charges into the charge transport molecule differs according to the polarity of the charge, which makes it difficult for a single molecule to transport both the positive and negative charges. In many cases, the charges of the different polarities are transported by hopping over different kinds of molecules. Therefore, it is possible to transport the positive or negative charge, e.g., electrons, by controlling the kind and concentration of the molecules.

In this case, the charge is transported by the drift caused by the diffusion, if an electric field is applied from outside. As a result, the charge density within the recording layer is inclined, or the charge within the recording layer is polarized, so as to form a strong electric field inside the recording layer, and the charge is brought back again to the original state by the electric field due to drifting. Finally, the holes are rearranged until the sum of the drift current caused by the internal electric field and the diffusion current (or the drift current caused by the external electric current if there is an external electric current) becomes zero. It should be noted that the refractive index of a nonlinear optical material is changed by the generated internal electric current, and the interference fringe is recorded as a refractive index modulated grating. If the recording medium is irradiated with a reference light, the reference light is diffracted by refractive index modulated grating so as to generate an object light component, with the result that the recorded data is reproduced.

An inorganic ferroelectric crystal is widely known as a photorefractive medium that permits recording the data by the mechanism described above. In recent years, a photorefractive polymer, which has a dielectric constant greatly lower than that of an inorganic crystal, is expected to have a good performance and to achieve a high response speed, and which can be manufactured easily, is being developed vigorously. The photorefractive polymer is a complex body of molecules performing the functions of charge generation, charge transport, trapping, and electrooptical effect. It is possible to perform the tuning of the characteristics by changing the combination of the molecules in accordance with the usage situation.

Compared with the inorganic ferroelectric crystal, the photorefractive polymer is expected to achieve a high response speed. However, the response speed (recording rate) of the system that has been reported to date is insufficient for producing a commercial recording medium using the photorefractive polymer, which is one of the reasons why the photorefractive polymer has not been used yet. Even if the recording of a high capacity can be achieved, it is impossible to put the photorefractive polymer to practical use if recording data takes a long time.

One of the reasons why a photorefractive polymer fails to achieve a high response speed is that the light utilization efficiency is extremely low. If a recording medium containing a photorefractive polymer is irradiated with light, the light is partly absorbed by the charge generating material, and the absorbed light is partly changed into a charge. Further, the charge thus formed is partly trapped so as to contribute to the formation of a space electric field, thereby recording data.

A recording medium having a low optical concentration, in which the irradiation light is absorbed only partly by the charge generating material, is formed because it is necessary to record the diffraction grating in the three dimensional direction in the depth direction of the recording medium for the angle multiplex recording of the hologram. Since it is necessary for the diffraction grating to be formed uniformly in the depth direction of the recording medium, used is a recording medium having an optical concentration that permits partial transmittance of the irradiation light.

In the next process of the charge generation step, it is known to the art that the charge generation efficiency from an organic material is very low, and is dependent on the electric field and the temperature.

As described above, in a recording medium utilizing the photorefractive effect, it was difficult in principle to increase the sensitivity. In view of the situation, an object of the present invention is to provide a data storage medium having a high capacity and achieving a high recording speed, and a data storage apparatus for recording data in the particular data storage medium.

### BRIEF SUMMARY OF THE INVENTION

According to one aspect of the present invention, there is provided a data storage medium, comprising:

a recording layer containing molecules having a charge transport characteristics, molecules having a nonlinear optical characteristics, and optical functional molecules whose stereostructure is changed depending on a light irradiation; and

a pair of transparent ohmic electrodes sandwiching the recording layer, the conductivity of the data storage medium being lowered by the light irradiation.

According to another aspect of the present invention, there is provided a data storage apparatus, comprising:

a data storage medium including a recording layer containing molecules having a charge transport characteristics, molecules having a nonlinear optical characteristics, and optical functional molecules whose stereostructure is changed according to light beam irradiation, and a pair of transparent ohmic electrodes sandwiching the recording layer, the conductivity of the data storage medium being lowered by the light beam irradiation;

a power source applying an electric field between the pair of transparent ohmic electrodes of the data storage medium;

a light source irradiating the data storage medium with the light beam;

a beam splitter dividing the light beam into two sections;

a spatial light modulator adding a data to be recorded to one of the divided light sections; and

an optical architecture allowing the divided two light sections to cross each other within the data storage medium forming an interference fringe in the recording layer of the data storage medium so as to write data.

### BRIEF DESCRIPTION OF THE SEVERAL VIEWS OF THE DRAWING

FIGS. 1A and 1B are conceptual views for explaining the mechanism for recording in a data storage medium according to one embodiment of the present invention; and

FIG. 2 schematically shows the construction of the data storage apparatus according to one embodiment of the present invention.

### DETAILED DESCRIPTION OF THE INVENTION

The recording of data into a conventional recording medium containing a photorefractive polymer can be explained as follows. Specifically, the irradiation light, generated in the form of an interference fringe, by crossing a signal light irradiating the data storage medium with a reference light, is absorbed first by a charge generating material, with the result that an optical charge is generated from the charge generating material with a certain probability. The optical charge thus generated is transported and, then, trapped at a certainly probability so as to form a space electric field and to cause data to be recorded finally. Since the efficiency in each step is lower than 1, it is difficult to increase the utilization efficiency of the light that can be defined as a ratio of the photons finally governing the data storage to all the photons of the recording light used for data storage.

The present inventors have found that the charge-generation process in the recording process using the conventional photorefractive effect can be replaced by the phenomenon of the charge injection from an electrode, and that the efficiency can be further increased by injecting the charges in this fashion. The data irradiating the data storage medium as an optical pattern can be recorded by trapping the charges injected from the outside by utilizing the optical functional molecule. Therefore, it is necessary for the recording layer included in the recording medium according to the embodiment of the present invention to contain optical functional molecules whose stereostructure can be changed by light irradiation.

It is also necessary for the recording medium according to the embodiment of the present invention to include a transparent ohmic electrode for injecting the charges. It is known to the art that various molecules and films permit the charge to be injected from an electrode in the case of suitably selecting the material of, for example, the metal used as an electrode. Also, the phenomenon known as “optical injection” can be employed in the embodiment of the present invention. It suffices for the charges to be trapped finally in accordance with the pattern of the irradiation light. It follows that it is possible for the charges to be injected from the electrode before irradiation with a recording light, during irradiation with the recording light, or after irradiation with the recording light.

The embodiment of the present invention will now be described, covering the case where data is recorded by simultaneously performing the charge injection and the light irradiation. Specifically, a signal light having data added thereto in advance is crossed with a reference light capable of interference with the signal light while applying voltage in a manner to permit the charges to be injected from the electrode. Since the data storage medium contains the optical functional molecules, i.e., the molecules whose properties are changed by the recording light so as to contribute to the trapping of the charge, the charge injected from the electrode is trapped in accordance with the irradiation pattern of the light, so as to bring about a distribution of the space charge. Since the data storage medium also contains a nonlinear optical material, the recording is performed as a refractive index modulated pattern by the space charge derived from the distribution of the space charge.

As described above, the recording medium according to the embodiment of the present invention contains optical functional molecules whose stereostructure is changed by light irradiation. Therefore, the charge is trapped by the mechanism described in the following. Specifically, any of the ionization potential, the permanent dipole moment and the mobility for determining the charge transport capability of the optical functional molecule whose stereostructure is changed so as to permit the optical functional molecule to contribute to the trapping of the charge. In some cases, at least two of these three properties are related to each other. The optical functional molecule serves to trap directly the charge or to assist the trapping of the charge.

The charge trapping mechanism will now be described more in detail.

The molecules whose ionization potential, i.e., the highest occupied molecular orbital (HOMO), is changed by the light irradiation include, for example, a photochromic molecule. The HOMO level is rendered deep or shallow depending on the change in the structure caused in the photochromic molecule by the light excitation.

(Mechanism 1)

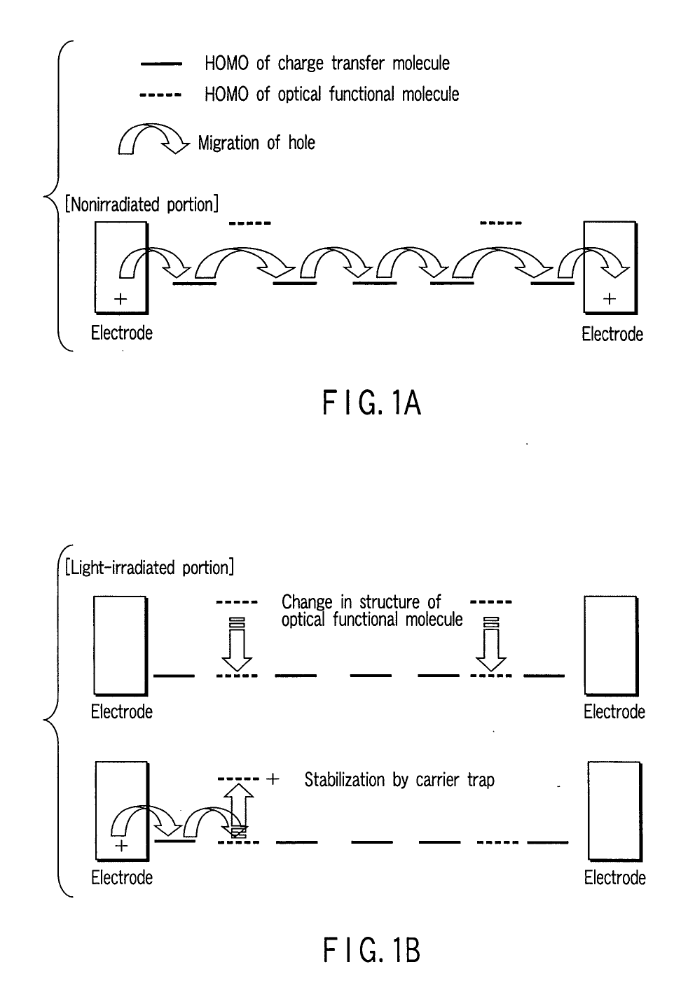

FIGS. 1A and 1B are conceptual views collectively showing the mechanism for recording the data in the recording medium according to one embodiment of the present invention. The example shown in the drawing covers the case where the charge to be transported is a hole, and the optical functional molecule having the HOMO deepened by the light irradiation is contained in the recording medium.

If the charge transport material contained in the recording medium has a HOMO having a level close to that of the HOMO of the optical functional molecule after the light irradiation, almost none of the charges are trapped by the optical functional molecule in the region (dark portion of the interference fringe), which is not irradiated with light or which has a weak light irradiation intensity, as shown in FIG. 1A. This phenomenon is brought about by the situation that, since the energy level of the hopping site involved in the charge transport function widely differs from the energy level of the highest occupied molecular orbital (HOMO) of the optical functional molecule, the optical functional molecule fails to act as the trapping site of the charge.

On the other hand, in the region irradiated with light, the HOMO of the optical functional molecule has an energy level close to the energy level of the hopping site of the charge transport molecule, as shown in FIG. 1B. As a result, the charge is rendered capable of migration from the charge transport molecule into the optical functional molecule. By the injection of the hole, which is a charge, the optical functional molecule is charged positive so as to be changed into the structure that is most stable under the particular state. In this case, the HOMO level is rendered shallow, and the trapped charge ceases to be migrated into the adjacent charge transport molecule so as to be trapped.

(Mechanism 2)

Mechanism 1 described above covers the optical functional molecule in which the energy level of the HOMO is rendered deep by the light irradiation. However, it is also possible to use a molecule that undergoes the opposite change. In this optical functional molecule, the energy level of the HOMO is rendered shallow by the light irradiation, so as to permit the optical functional molecule to be capable of receiving a hole. It should be noted that the optical functional molecule that is further stabilized by the charging in the positive polarity performs the function of the trapping site as in mechanism 1 described above.

As a mechanism for the optical functional molecule to trap the charge, it is possible to use the change in the permanent dipole moment or the charge transport characteristics, in addition to the change in the ionization potential (HOMO) described above.

(Mechanism 3)

In the case of using an optical functional molecule having the permanent dipole moment increased by the light irradiation, the optical functional molecule performs the function described below so as to record the data. As described in “Physical Review B, Vol. 56, Num. 6, RC R2904”, the density of states of the hopping site is broadened by the dipoles of the molecules forming the recording medium. The width of the density of states fluctuation is changed depending on the magnitude of the dipole and the dipole concentration such that the width of the fluctuation in the density of states of the hopping site is increased with increases in the magnitude of the dipole and in the dipole concentration. If the other factors are assumed to be constant, the mobility and the diffusion coefficient of the charges are diminished by the increase in the width of the fluctuation of the density of states.

The probability for the charge to be trapped by the trapping molecule is dependent on the probability of the presence of the charge in the region in which the trapping molecule is present. The charge in the light-irradiated region is present in the particular region for a long time because the migration rate of the charge is decreased by light irradiation, with the result that the concentration of the trapped molecules is rendered high, compared with the nonirradiated region. The data is recorded by the distribution of the space charge field derived from the increased concentration of the trapped molecules.

In contrast, in the case of using the optical functional molecule in which the permanent dipole moment is diminished by light irradiation, the mobility of the carrier in the light-irradiated portion is rendered high, with the result that the carrier in the light-irradiated portion is migrated more promptly than in the nonirradiated portion, which makes it difficult to record data.

Also, in the recording medium in which the dipole is changed by the light irradiation, it is possible for the charge to be trapped by the mechanism, so that the charge is stabilized in a dielectric fashion to be bound strongly to the molecule.

Further, the mobility is included in the charge transport characteristics. In the recording medium according to the embodiment of the present invention, the carrier is transported by the hopping. The term “hopping” denotes the conduction by the jumping of the carrier from localized site to site. In the recording medium according to the embodiment of the present invention, the hopping corresponds to the jumping of the carrier from a charge transport molecule into another charge transport molecule.

In the hopping process, a carrier in a certain localized energy level is migrated into the adjacent vacant localized energy level by the tunnel effect under the assistance of the lattice vibration. The mobility is a function of the distance between the localized energy levels, the expansion of the wave function of the localized energy level, the frequency of the phonons, the expansion of the density of states, the temperature, and the electric field. The coefficient used for describing the charge transport characteristics also includes a diffusion coefficient together with the mobility. The diffusion coefficient can also be represented by a function of parameters like the mobility. Although both the mobility and the diffusion coefficient are involved in the recording, the easiness for the carrier to migrate is defined by the mobility because the mobility and the diffusion coefficient are related to each other.

The examples of the mechanism in which the mobility is changed include, for example, mechanism 4 and mechanism 5 given below.

(Mechanism 4)

Some mechanisms in which the charge transport characteristics are changed by the light irradiation are known to the art in addition to the mechanism in which the dipole moment is changed. One of these mechanisms is a method in which a photochromic molecule is used. The photochromic molecule used in this method is a molecule in which the conjugate system is bonded/cut by the photoreaction such that the on/off operation of the charge transmission within the molecule can be controlled. As a result, the bright portion and the dark portion of the interference fringe are rendered different from each other in respect of the distance and the concentration of the localized energy level. This corresponds to the situation that the mobility is changed. Since the recording medium contains trapping molecules, the probability of the presence of the carrier is rendered high in the region in which the mobility is slightly changed and, thus, the number of carriers trapped by the trapping molecules is increased. As a result, the modulated pattern of the mobility is recorded in the recording medium as a modulated pattern of the trap concentration.

(Mechanism 5)

The charge can also be trapped by changing the stereostructure of the optical functional molecule. This is a method in which the expansion in the distance between the localized energy levels or in the wave function of the localized energy levels is changed by changing the so-called “off-diagonal disorder” so as to change the mobility and, thus, to trap the charge. In order to permit the hopping of the charge between the molecules, it is necessary for the transfer integral between the molecules to have a reasonable magnitude. Even in the molecules capable of transporting the charge, it is difficult for the molecules to transport the charge under the state that these molecules are isolated in space, with the result that these molecules provide the trapping sites of the charge. The charge can be trapped if it is possible to isolate the charge transport molecules by changing the stereostructure of the optical functional molecules.

In the embodiment of the present invention described above, the data is recorded in the recording medium by irradiating the recording medium with a signal light and a reference light while injecting the charge from the electrode into the recording medium. However, the present invention is not limited to the embodiment described above. It is possible for the charge to be injected from the electrode either before or after the light irradiation.

Since the recording medium of the present invention contains the optical functional molecule performing the particular functions described above, the number of carriers is decreased when the recording layer included in the recording medium according to the embodiment of the present invention is irradiated with a recording light. To be more specific, the number of carriers is decreased because the charge is trapped by the light irradiation so as to decrease the number of carriers, i.e., the charge capable of migration. The phenomenon that the number of carriers is decreased by the light irradiation is one of the phenomena prominently differing from the phenomena inherent in the conventional photorefractive polymer. Since the photorefractive polymer contains a charge generating material that generates the charge upon light irradiation, the optical charge generated from the charge generating material is trapped so as to be recorded in the recording medium containing the photorefractive polymer. It follows that the number of carriers capable of migration is increased in the light-irradiated portion of the conventional recording medium and, thus, the number of carriers in the light-irradiated portion is larger than the number of carriers in the nonirradiated portion.

When data is recorded in the recording medium according to the embodiment of the present invention, it suffices for the charge (carrier) to be injected from the electrode into the recording medium before the recording is finished. The recording medium according to the embodiment of the present invention contains the charge transport molecules for transporting the injected carriers.

The stereostructure of the optical functional molecule contained in the recording medium according to the embodiment of the present invention is changed by the light irradiation so as to modulate the ionization potential, the permanent dipole moment or the mobility, thereby finally modulating the conductivity. The methods of measuring these properties will now be described.

First of all, the conductivity is measured from the ordinary current that flows upon application of voltage. To be more specific, the conductivity is obtained by dividing the current density (value of current per unit area) obtained by measuring the current by the electric field. Since the conductivity changes according to, for example, the material of the electrode, the shape of the film, and the impurity concentration, the conductivity of a substance is generally measured in a region called an ohmic region by changing the material of the electrode. However, the conductivity handled in the present invention represents the conductivity as an element. The element of the present invention is constructed such that the element is sandwiched between a pair of electrodes, and the conductivity is measured from the current that is detected by connecting the power source and the ammeter to the electrodes arranged on the upper surface and the lower surface of the film.

In general, the ionization potential can be examined by vacuum ultraviolet photoelectron release (UPS). As a simple and convenient method, the ionization potential can be examined by a photoelectron releasing apparatus under an air atmosphere, developed by Rikagaku Kenkyu-jo (Scientific Research Laboratory). The values of the ionization potential are rendered nonuniform according to the shape of the sample and the set up in the measuring stage. In general, the output is plotted relative to the irradiation light energy so as to obtain the ionization potential from the extrapolated value. It is also possible to obtain the ionization potential by an electrochemical method.

The method of measuring the permanent dipole moment is described in detail in “M. Sugiuchi and H. Nishizawa, J. Imag. Sci. Technol. 37, 245 (1993)”.

The mobility is calculated in general from the measured value of the transient photocurrent. This method is also called a “time of flight” method. The methods of the measurement and the calculation are described in detail in “A. Hirao, H. Nishizawa, and M. Sugiuchi, Phys. Rev. Lett. 75, 1787 (1995)”.

It is possible to use a molecule whose stereostructure is changed so as to change the permanent dipole moment as the optical functional molecule contained in the optical recording medium according to the embodiment of the present invention. In this case, it is desirable for the permanent dipole moment to be changed by 0.7 debye or more. It should be noted in this connection that the density of states of the hopping sites is changed by the change in the permanent dipole moment, as described in “A. Hirao and H. Nishizawa, Phys. Rev. B56, RC2904 (1997)”. Although the density of states is changed by, for example, the intermolecular distance and the dielectric constant in addition to the permanent dipole moment, the width of the density of states is changed by about kT/2 if the dipole is changed by 0.7 debye under the typical state that the intermolecular distance is 1.2 nm and the relative dielectric constant is 3.0. The width of the density of states needs to be changed by about kT/2 in order to efficiently obtain the effect of the present invention.

It should also be noted that a molecule whose stereostructure is changed so as to change the ionization potential can be used as the optical functional molecule contained in the optical recording medium according to the embodiment of the present invention. It is desirable for the ionization potential to be changed by at least 0.01 eV. It should be noted in this connection that, as described above in conjunction with the permanent dipole moment, the change of about kT/2 in the width of the density of states is required for allowing the effect of the present invention to be exhibited efficiently and, thus, it is necessary for the ionization potential to be changed by at least 0.01 eV as described above.

Further, it is possible to use a molecule whose stereostructure is changed so as to change the mobility as the optical functional molecule contained in the optical recording medium according to the embodiment of the present invention. It is desirable for the change in the mobility to be decreased to a level not higher than 0.5 times as high as the level before the light irradiation. It should be noted in this connection that, as described above in conjunction with the permanent dipole moment and the ionization potential, the change of about kT/2 in the width of the density of states is required for effectively producing the effect of the present invention and, thus, it is desirable for the change in the mobility to be decreased to a level not higher than 0.5 times as high as the level before the light irradiation, as described above. To be more specific, if the typical values are substituted in the experimental formula relating to the dependence of the mobility on the temperature and the electric field, the change in the mobility is decreased to about 0.5 to 0.1 times as much as the level before the light irradiation on the assumption that the width in the density of states is increased by about kT/2. The experimental formula for the mobility, which is referred to above, is an experimental formula known as “Disorder Formalism”, which is disclosed in “H. Basseler, Phys. Status Solidi B175, 15(1993)”.

The charge transport molecule is a molecule that permits transporting the electrons or holes. It is possible for the molecule capable of transporting the charge to be a molecule alone or to be a polymer or a copolymer with another polymer. The charge transport molecule used in the present invention includes, for example, nitrogen-containing cyclic compounds such as indole, carbazole, oxazole, isoxazole, thiazole, imidazole, pyrazole, oxadiazole, pyrazoline, thiathiazole and triazole, the derivatives thereof and the compounds having the nitrogen-containing cyclic compound referred to above on the backbone chain or the side chain; hydrazone compounds, triphenyl amines, triphenyl methane, butadienes, stilbenes, quinone compounds such as anthraquinone and diphenoquinone, the derivatives thereof and the compounds having these compounds on the backbone chain or the side chain; fullerenes such as C₆₀ and C₇₀, and the derivatives thereof; the π-conjugate system polymer or oligomer such as polyacetylene, polypyrrole, polythiophene and polyaniline; σ-conjugate system polymer or oligomer such as polysilane and polygermane; and polycyclic aromatic compounds such as anthracene, pyrene, phenanthrene and coronene.

The nonlinear optical material whose refractive index is changed by the application of an electric field, includes, for example, 1) a substance whose absorption coefficient or reflectance is changed by the Franz-Keldysh effect, and 2) a substance whose refractive index is changed by the Pockels effect.

To be more specific, the nonlinear optical material includes, for example, the liquid crystal materials including p-azoxy ethyl benzoate, ammonium oleate and p-azoxy anile; urea and its derivatives; thiourea and its derivatives; nitrobenzenes; carbonyl benzenes; π-conjugate system benzene derivatives such as benzene sulfonate; pyridine N-oxides; pyridine derivatives such as nitro pyridines; π-conjugate system polymers and oligomers such as polyacetylene, polypyrrole, polythiophene and polyaniline; σ-conjugate system polymers and oligomers such as polysilane and polygermane; polycyclic aromatic compounds such as anthracene, pyrene, phenanthrene and coronene; nitrogen-containing cyclic compounds such as indole, carbazole, oxazole, isoxazole, thiazole, imidazole, pyrazole, oxadiazole, pyrazoline, thiathiazole and triazole, and the compounds having the nitrogen-containing cyclic compound referred to above on the backbone chain or the side chain; hydrazone compounds, triphenyl amines, triphenyl methanes, benzene amines, butadienes, stilbenes, orphenes, imines, piperonal, TCNQ, anthraquinone diphenoquinone, and the derivatives thereof; and fullerenes such as C₆₀ and C₇₀, and the derivatives thereof.

These materials can be used singly or in the form of a mixture of at least two of these materials. It is desirable for the mixing amount of these materials to fall within a range of between 0.01% by weight and 80% by weight based on the entire recording layer. Where the content of the nonlinear optical material is lower than 0.01% by weight, it is difficult to obtain a sufficient change in the optical characteristics. On the other hand, if the content of the nonlinear optical material exceeds 80% by weight, the nonlinear optical material is agglomerated and crystallized, resulting in failure to form an element in which different molecules are dispersed.

Among the nonlinear optical materials exemplified above, the nitrogen-containing compounds and the conjugate system compounds perform the function of trapping the charge and, thus, can also be used as the trapping material described herein later.

The molecules whose stereostructure is changed by the light irradiation is used as the optical functional molecule. To be more specific, the optical functional molecules exhibiting photochromism includes, for example, spiro pyrans such as spiro benzothio pyran; spiro oxazines; fulgides; cyclophenes; diaryl ethene series compounds; chalcon derivatives; azo benzene series compounds; polyacrylate or polysiloxane having a cyano biphenyl group, which is prepared by allowing a high molecular weight liquid crystal material to contain a photochromic molecule; and molecules exhibiting photochromism such as polysiloxane having a spiro benzofuran group. It is possible to use in combination a multiplicity of different kinds of the optical functional molecules exemplified above as far as the molecules are equal to each other in the wavelength under which the stereostructure is changed.

It is absolutely necessary for the optical functional molecules described above to be capable of absorbing the recording light. However, where the recording medium contains a large amount of the optical functional molecules having a very high optical concentration relative to the recording light, the recording light irradiating the recording medium is absorbed in the vicinity of the surface of the recording medium, with the result that it is possible for the recording light to fail to reach the optical functional molecule present inside the element. It follows that it is desirable to determine the content of the optical functional molecules such that the optical density (cm⁻¹) in the element falls within a range of between 10⁻⁶ and 10. For example, it is desirable to mix the optical functional molecules in an amount of about 0.1 to 20% by weight based on the entire recording layer.

It is possible for the nitrogen-containing compounds and the compounds having the conjugate system, which are included in the optical functional molecules exemplified above, to exhibit the charge transport capability. In such a case, it is also possible for the compounds noted above to perform the function of the charge transport material.

Where the optical functional molecule fails to perform the function of the trapping material, it is possible to mix separately a trapping material. Since it is necessary for the trapping material to receive and trap the charge, the molecules having a donor-like group or an acceptor-like group are used as the trapping material like the charge transport material. To be more specific, the trapping material includes, for example, allyl alkane; nitrogen-containing compounds such as indole, carbazole, oxazole, isoxazole, thiazole, imidazole, pyrazole, oxadiazole, pyrazoline, thiathiazole, and triazole; oxygen-containing compounds such as fluorenone and derivatives thereof, diphenoquinone and derivatives thereof, anthraquinone and derivatives thereof, and sulfur-containing derivatives.

It is possible for the hydrogen atom bonded to that portion of the compounds exemplified above which has a small influence given to the charge transport function to be replaced by an optional atomic group such as an alkyl group, an alkoxy group, a phenyl group, a naphthyl group, a tolyl group, a benzyl group, a benzo thiazolyl group, a benzo oxazolyl group, a benzo pyrrole group, a benzo imidazolyl group, a naphtho thiazolyl group, a naphtho oxazolyl group, a naphtho pyrrole group, a naphtho imidazolyl group or a hydroxyl group.

A desirable trapping material includes a compound having a conjugate system positioned in the center and donor-like or acceptor-like atomic groups substituted in both edge portions of the conjugate system. Depending on the construction of the central conjugate system, the construction of the compound can be stabilized by the entry of a positive or negative charge so as to permit the compound to act as a trapping material of a high performance.

Where a trapping material is contained in the recording layer, it is desirable for the trapping material content to fall within a range of between 0.1% by weight and 40% by weight based on the entire recording layer. Where the content of the trapping material is lower than 0.1% by weight, the dispersed amount of the trapping material is excessively small, with the result that an excessively long time is required for the charge formed by the photoreaction to be caught by the trapping material. On the other hand, if the content of the trapping material exceeds 40% by weight, the trapping material is dispersed in an excessively large amount, with the result that the charge formed by the photoreaction is trapped before the charge is sufficiently released. It follows that it is difficult to form a sufficient internal electric field. In this case, it is desirable to use the charge transport material in an amount falling within a range of between 1% by weight and 70% by weight based on the entire recording layer. It is desirable for the charge injected from the electrode to perform the hopping function among the charge transport molecules so as to be finally trapped by the trapping material and, thus, to form an internal electric field. Where the content of the charge transport material is lower than 1% by weight, the charge is not transported and, thus, it is difficult to form the internal electric field. On the other hand, if the content of the charge transport material exceeds 70% by weight, the charge transport molecules are agglomerated and crystallized, resulting in failure to form an element in which different kinds of molecules are dispersed.

It is possible to use the charge transport material, the nonlinear optical material, the optical functional material and the trapping material, which is mixed as required, described above, in a suitable combination. Also, it is possible to use a polymer having an optically functional atomic group bonded to the side chain as the trapping material, the charge transport material or the nonlinear optical material.

Incidentally, where the components such as the charge transport material are not formed of polymers, it is possible to mix a polymer in addition to the components described above. The polymer is not particularly limited, though it is desirable for the polymer to be optically inactive. To be more specific, the polymer used in the present invention includes, for example, a polyethylene resin, a nylon resin, a polyester resin, a polycarbonate resin, a polyarylate resin, a butyral resin, a polystyrene resin, a styrene-butadiene copolymer resin, a polyvinyl acetal resin, a diaryl phthalate resin, a silicone resin, a polysulfone resin, an acryl resin, a vinyl acetate resin, a polyolefin oxide resin, an alkyd resin, a styrene-maleic anhydride copolymer resin, a phenolic resin, a vinyl chloride-vinyl acetate copolymer, a polyester carbonate, a norbornene series resin, a polyvinyl chloride, polyvinyl acetal, a polyarylate, and a paraffin wax. These polymers can be used singly or in the form of a mixture of at least two of these polymers.

Also, in order to lower the glass transition point of the recording medium, it is possible to disperse molecules called a plasticizer, which have a low molecular weight. The stereostructure of the optically functional molecule can be changed more easily by lowering the glass transition point of the recording medium.

Further, it is possible to add a compound generally known as a high molecular weight antioxidant or an ultraviolet light absorbing agent to the components described above. The particular compound, which is generally known as a high molecular weight antioxidant or an ultraviolet light absorbing agent, includes, for example, hindered phenols, aromatic amines, organic sulfur compounds, phosphites, a chelating agent, benzophenones, benzotriazoles, and nickel complex compounds. It is desirable for these compounds to be mixed in an amount falling within a range of between 0.0001 and 10% by weight based on the entire recording layer.

It is possible to form the recording layer included in the recording medium according to one embodiment of the present invention by dissolving a composition containing the components described above in a solvent, followed by forming a film by using the resultant solution. Various organic solvents can be used as the solvent for dissolving the components described above including, for example, alcohols, ketones, amides, sulfoxides, ethers, esters, aromatic halogenated hydrocarbons and aromatic hydrocarbons.

The recording layer can be formed by, for example, various coating methods such as a spin coating method, a dip coating method, a roller coating method, a spray coating method, a wire bar coating method, and a blade coating method; a casting method; a vacuum vapor deposition method; and a sputtering method. In the coating method, the recording layer can be formed by evaporating the solvent of a solution containing the charge transport material, the nonlinear optical material, and the optically functional molecules. In this case, it is possible for the components dissolved in the solvent to be either molecules or polymers as far as the molecules or polymers exhibit desired characteristics. It is also possible to form the recording layer by, for example, rapidly cooling a mixture under a heated state without using a solvent. Further, it is possible to form the recording layer by, for example, a plasma CVD method utilizing a glow discharge. It is also possible to form the recording layer not only by casting a solution but also evaporating the solvent from the solution, followed by melting under heat the powdery mixed material obtained after evaporation of the solvent from the solution. This method is also called an injection method.

In the typical case, the recording medium can be prepared by the method described in the following. In the first step, the optically functional molecules, the charge transport molecules and nonlinear optical material and, as desired, a matrix polymer are dissolved in an organic solvent such as toluene, followed by drying the resultant solution so as to distill the solvent. Also, a spacer for adjusting the film thickness is arranged on a heated quartz substrate, and the dried material is disposed on the substrate. Then, a sample having a desired thickness is prepared by pushing another substrate against the sample from above so as to obtain a recording layer.

It is desirable for the recording layer thus obtained to have a thickness of generally 0.05 to 10 mm, and desirably 0.2 to 1 mm. Incidentally, it is possible to select appropriately the thickness of the recording layer in accordance with the characteristics and the composition required for the recording medium such as the recording capacity and the light transmittance.

For example, the recording layer can be formed by coating an appropriate support body with a solution containing a composition having the components described above. It is possible to use as the support body an optional material having an appropriate thickness and hardness and a mechanical strength high enough to permit the material to be handled without difficulty.

The recording medium according to the embodiment of the present invention can be obtained by peeling the recording layer thus formed from the support body and having the resultant recording layer held between a pair of transparent ohmic electrodes. The transparent ohmic electrode can be formed by using a material that permits the charge to be injected into the recording medium. Since the data is recorded by irradiating the recording layer with light, it is necessary for the electrodes having the recording layer held therebetween to be transparent. Incidentally, the term “transparency” implies that the electrode is transparent to the extent that at least 40% of the irradiating light can be transmitted through the electrode. The ohmic electrode is an electrode that permits efficiently injecting the charge carrier of a desired polarity into the recording medium. In the ideal case, the applied electric field is proportional to the number of injected carriers in the ohmic electrode. However, it is practically rare for Ohm's law to be established strictly. In other words, the ohmic electrode denotes an electrode that permits increasing the number of carriers with increase in the applied voltage. It is desirable to use indium oxide (ITO) for forming the ohmic electrode because indium oxide has a high transparency. Also, it is desirable to select an appropriate electrode material in view of the aspect that the charge can be injected easily into the recording layer. The material adapted for forming the transparent ohmic electrode is selected in accordance with the molecules contained in the recording layer. For example, where the hole transport material represented by p-diethyl amino benzalde diphenyl hydrazone (DEH) is contained mainly in the recording layer, it is desirable to use an Au electrode as the transparent ohmic electrode. Among the hole transport material, there is a system that permits the charge injection to be carried out better from an ITO electrode or an Al electrode than from the Au electrode. Also, where 3,5-dimethyl-3′,5′-di-t-butyl-4,4′-diphenoquinone (DMDB), which is an electron transport material, constitutes the charge transport material, it is desirable to use, for example, Mg as the electrode material.

In some cases, it is possible to use the support body used for forming the recording layer as the substrate of the recording medium according to the embodiment of the present invention, as in the case where the transparent support body, on which the transparent ohmic electrode is formed as described above, is used for forming the recording layer. To be more specific, it is possible for the recording medium according to one embodiment of the present invention to comprise a recording layer, a pair of transparent ohmic electrodes having the recording layer sandwiched therebetween, and the substrate on which the ohmic electrode is formed. It is desirable for the substrate in this case to be transparent to some extent under the wavelength region of the light used for the recording. Incidentally, in the case of a semiconductor laser, the wavelength of the light is, for example, 780 nm, 650 nm or 405 nm. The ordinary resin is transparent to the visible light having a wavelength falling within a range of between 400 nm and 600 nm, and maintains the transparency in many cases under a long wavelength region of up to about 800 nm. Such being the situation, it is desirable to use, for example, polyvinyl chloride, polyvinylidene chloride, polyethylene, polycarbonate, polyester, polyamide, acrylic resin or polyimide for forming the substrate on which the ohmic electrode is formed. It is also desirable to use a cycloolefin polymer or a norbornene resin, which are transparent amorphous polymers developed in recent years, for forming the substrate in question.

It is possible to apply a poling treatment in advance to the recording medium according to one embodiment of the present invention. In this case, the recording layer is heated to a temperature substantially equal to the glass transition point, and an external electric field is further applied to the heated recording layer. As a result, it is possible to align the molecules having a large permanent dipole moment, particularly, a nonlinear optical material, in the direction of the external electric field so as to increase the nonlinear characteristics relative to the light.

The method of recording data in the recording medium and reproducing the recorded data will now be described, covering the case where the recording medium according to the embodiment of the present invention is used as a hologram memory. The recording medium according to the embodiment of the present invention can be used in any of the transmission type angular multiplex recording system and the reflection type polarized light collinear recording-reproducing system. In the transmission type angular multiplex recording system, a recording layer having a thickness of about 100 μm is irradiated simultaneously with a recording light and a reference light so as to record the interference fringe. The interference fringe is recorded in the angular multiplex mode while changing the relative incident angle between the recording light and the reference light. In reproducing the recorded data, the recorded site of the recording layer is irradiated with the reference light alone while changing the angle so as to read the diffracted light. The transmission type angular multiplex system outlined above is advantageous in that it is possible to easily obtain a very large storing capacity.

In the reflection type polarized light collinear recording-reproducing system, used is a recording medium having a reflection body formed on one side of the transparent substrate, and having a hologram recording layer formed on that side of the substrate which is opposite to the side on which the reflection body is formed. Both the recording light and the reference light are allowed to be coaxially incident on the recording medium from the side of the hologram recording layer. It should be noted that the focal point is positioned on the reflection surface, which is the surface of the reflection body referred to above. The recording light or the reference light reflected from the reflection surface is allowed to interfere with the incident reference light or recording light within the hologram recording layer, with the result that the interference fringe is recorded in the hologram recording layer.

It is possible to employ a shift multiplex mode in the multiplex recording mode in the reflection type polarized light collinear recording-reproducing system. For example, where a single recording area has a diameter of hundreds of microns, which is dependent on the thickness of the substrate and on the thickness of the recording layer, different interference fringes are recorded and reproduced by the shifting of about 10 μm. As in the angular multiplex mode, it is physically possible to form a multiplicity of interference patterns in the same site and to reproduce independently the formed interference patterns. In the reflection type collinear recording-reproducing system, it suffices to use a single optical system and to permit the incident optical system and the detecting optical system to have the same construction. It follows that the reflection type collinear recording-reproducing system is free from the requirement for the accurate positioning of the optical systems as required in the transmission type system described above. Further, the reflection type system is advantageous in that the system is interchangeable with DVD and CD available nowadays.

In the case of employing the reflection type polarized light collinear recording-reproducing system, it is possible for one of the ohmic electrodes to perform the function of the reflection body. The recording medium is constructed as follows:

\mathring{1} protective layer/reflection body/transparent intermediate layer/ohmic electrode/recording layer/ohmic electrode/protective layer

\mathring{2} protective layer/reflection body (ohmic electrode) /recording layer/ohmic electrode/protective layer

\mathring{3} protective layer/reflection body/transparent intermediate layer/ohmic electrode/recording layer/ohmic electrode/transparent intermediate layer/protective layer

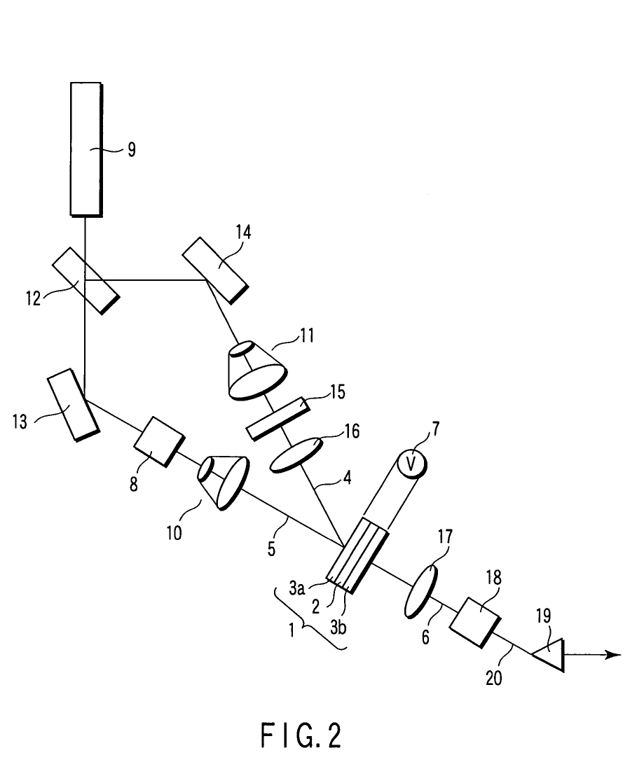

FIG. 2 schematically shows the construction of a data storage apparatus according to the embodiment of the present invention. A recording layer 2 as described above is held between transparent ohmic electrodes 3a and 3b so as to form a recording medium 1. An image display element 15 is arranged on one side of the recording medium 1, and a reading device 18 is arranged on the opposite side of the recording medium 1. It is desirable for the reading device 18 to be arranged perpendicular to the optical axis of the light emitted from the image display element 15 for irradiating the recording medium 1.

The image display element 15 is an apparatus for displaying the data by controlling whether to guide or not to guide the light in a desired direction by changing the reflectance or the transmittance of the light. To be more specific, widely employed is, for example, the control as to whether to transmit or not to transmit the light by using a liquid crystal shutter and the control as to whether to reflect the light in a desired direction or in another direction by using a mirror array. Used for the desired control are, for example, a liquid crystal element, a digital mirror array, a Pockels readout optical modulator, a multi-channel spatial modulator, a Si-PLZT element, a deformed surface type element, an AO or EO modulating element, and a magnetooptical effect element.

It is possible to use an optional photoelectric conversion element as the reading device 18. For example, it is possible to use a CCD, a CMOS sensor, a photodiode, a photoreceptor, or a photomultiplier tube as the reading device 18.

In the apparatus shown in FIG. 2, the light is assumed to be transmitted through the image display element 15. However, it is possible for the image display element to be of the type of reflecting the light.

The data can be recorded in the recording medium 1 by the procedure described in the following. Specifically, it is necessary for a light source 9 to emit light capable of interference, i.e., a light represented by a laser light. The following description covers the case of using a laser light. It is possible to select the wavelength of the laser light in accordance with the components of the recording layer included in the recording medium. To be more specific, a light having an appropriate wavelength is selected as the recording light in accordance with the optically functional molecules contained in the recording layer such that the recording light can be absorbed by the optically functional molecules. The laser used in this case can be optionally selected from among the known gas laser, solid laser and semiconductor laser. The output beam generated from the laser is divided into two parts by using, for example, a beam splitter 12. One of the divided beams is used as a reference light 5, and the other divided beam is transmitted through the image display element 15 so as to be used as a signal light 4.

In recording the data in the recording medium 1 by using the apparatus of the particular construction, the signal light 4 and the reference light 5 are allowed to be incident on the recording medium 1 such that these signal light 4 and reference light 5 are allowed to cross each other within the recording layer 2. The particular operation is carried out by the procedure described in the following. In the first step, the light emitted from the laser 9 is expanded into parallel light by, for example, a beam expander (not shown), followed by dividing the parallel light into two parts by using, for example, the beam splitter 12. The data that is to be recorded is converted in advance into a digital signal, and an image pattern corresponding to the digital signal is inputted into the image display element 15. The image display element 1 is irradiated through a mirror 14 with one of the divided parts of the light beam divided by the beam splitter 12. The divided part of the light beam passing through the mirror 14 is spatially modulated in accordance with the data recording, for example, the intensity distribution of the light so as to form the signal light 4. Further, the signal light is converged by a lens 16 so as to permit the recording medium 1 to be irradiated with the converged light beam. Where the focal length of the lens is represented by f1, it is desirable for the distance between the image display element 15 and the lens 16 to be equal to f1, and it is also desirable for the distance between the recording medium 1 and the lens 16 to be substantially equal to f1,. The recording medium 1 is irradiated with the reference light simultaneously with the irradiation with the signal light 4 such that the signal light is allowed to cross the reference light 5 within the recording layer 2. It is possible for the reference light to be converged by a lens (not shown). In this case, an electric field is applied from an external power source 7 to the recording medium 1 so as to permit the charge to be injected into the recording layer from the electrodes 3a and 3b. An optical setup for recording, including an electronic control unit (an optical architecture) is constituted by the beam expander, the beam splitter 12, the mirror 14, the lens 16 and the mirror 13.

It is possible to select appropriately the voltage applied to the recording medium 1 in accordance with, for example, the thickness of the recording medium and the carrier injection efficiency. For example, the voltage applied to the recording medium 1 can be set at about 1 to 1000V. It should be noted, however, that it is desirable for the current of at least 1 pA/cm² to be caused to flow into the recording medium 1 by the voltage application. Where the current flowing into the recording medium 1 is smaller than 1 pA/cm², it is impossible for the recording to fail to be performed because the number of injected carriers is excessively small.

An interference fringe is generated in the recording layer 2 because the signal light 4 is superposed with the reference light 5, with the result that the stereostructure of the optically functional molecule is changed so as to cause the charge injected from the electrodes 3a and 3b to be trapped. As a result, an internal electric field is generated, and the optical characteristics are modulated so as to form a diffraction grating within the recording layer. In this case, it is possible to form a multiplicity of interference fringes in the overlapping region of the recording layer 2 by changing at least one of the incident angle of the reference light 5 and the incident angle of the signal light 4. Alternatively, it is possible to change the incident angle of each of the reference light 5 and the signal light 4 by rotating the recording medium 1 relative to the direction of the incident light. Further, it is possible to record a multiplicity of interference fringes in the overlapping region of the signal light 4 and the reference light 5 by deviating the site irradiated with the laser light by about ½ to 1/1000 from the overlapping region of the signal light and the reference light.

Since the data storage apparatus shown in FIG. 2 comprises a lens 17, the reading device 18, and a data converting device 19, it is possible to regenerate the data recorded in the recording medium 1 as an electric signal 20. In reading the recorded data, the signal light 4 is shielded first so as to cause the recording medium 1 to be irradiated with the reference light 5 alone. In other words, the reference light 5 can also be used as a reading light. In this case, a reproduced light 6 having a spatial intensity distribution equal to that of the signal light 5 is reproduced by the recorded interference fringe and, thus, the reproduced light 5 passing through the lens 17 can be read by the reading device 18. Where the focal length of the lens is represented by f2, it is desirable for the distance between the lens and the other lens to be equal to f1+f2. It is also desirable for the distance between the lens and the reading device to be equal to f2.

In the embodiment described above, a light source emitting a light beam having the same wavelength is used in each of the recording stage and the reading stage. However, the data storage apparatus of the present invention is not limited to the particular construction. Where the thickness of the recording layer 2 is not larger than about 0.5 mm, the recorded data can be read even in the case of using a light source emitting a light beam having the wavelength slightly differing from that of the light beam emitted in the recording stage. In such a case, it is possible to allow the reading light to be incident on the recording medium 1 at an angle slightly differing from that of the light incident on the recording medium 1 in the recording stage so as to increase the intensity of the diffracted light. It is desirable in this case, too, to arrange the reading device 18 perpendicular to the optical axis of the light used in the reading stage.

It should also be noted that the reference light 5 is also converged by using a lens in the embodiment described above. However, it is not necessary to converge the reference light. It is possible to omit the lens by arranging the beam expander in a desired position between the laser 9 and the image display element 5.

In reading the recorded data, it is also possible to perform the phase conjugate reproduction. In this method, the recording medium is irradiated with a light having the wavelength equal to that of the light used in the recording stage and capable of interference in a direction opposite to that in the recording stage.

To be more specific, the diameter of the light beam emitted from a laser, which oscillates the light having the wavelength equal to that of the light used in the recording stage, is expanded by using, for example, a beam expander and, then, the recording medium is irradiated with the light beam having the expanded diameter in the direction exactly opposite to that in the stage of irradiating the recording medium with the reference light. As a result, a virtual image is reproduced in the direction exactly opposite to the direction in which the signal light ran by the diffraction grating recorded in the recording medium. The virtual image passing through a lens is reflected by, for example, a beam splitter so as to be read by the reading device. It is desirable for the distance between the lens and the reading device to be equal to the focal length of the lens in this stage, too, as in the recording stage. It is possible to use the light having the wavelength slightly differing from that of the light used in the recording stage and capable of interference as the reading light in the phase conjugate reproduction, too. In this case, it is desirable to adjust slightly the incident angle of the reading light so as to permit the optical axis of the virtual image to coincide perfectly with the optical axis of the signal light.

Where the reference light is not converged in the recording stage, it is possible to omit the beam splitter and the lens even in the phase conjugate reproduction stage.

The data recorded in the recording medium can be erased by the method described in the following. For example, the recorded data can be erased by the method that the trapped charges are distributed again by uniformly irradiating the element with light or by heating the element so as to make the charge distribution uniform, or by the method that the trapped charged is allowed to be recombined with the charge of the opposite polarity. The method of making the charge distribution uniform is adapted for erasing the recorded data over a large region of the element. The recorded data can be erased by, for example, irradiating the recording medium with light having a uniform intensity distribution over a region larger than the recording region or by heating the recording medium to the temperature slightly lower than the glass transition point. On the other hand, the method for erasing the charge is adapted for the local erasure of the recorded data. In this case, it is necessary to impart a mechanism for generating the charge of the opposite polarity to the element. To be more specific, where the hole constitutes the charge, it is necessary to incorporate in the data storage apparatus a mechanism for injecting electrons into the recording medium and to allow the recording medium to contain the material for transporting the injected electrons.

Where the recording medium contains a trapping material, it is possible to irradiate uniformly the recording medium with light having a specified wavelength, i.e., the light that is not absorbed by the trapping material under a neutral state but is absorbed by the trapping material under an ionized state. It is possible to erase the recorded data by irradiating-the recording medium with the particular light referred to above.

The recording method and the reproducing method of data in and out of the recording medium according to one embodiment of the present invention are not limited to the examples described above. It is possible to modify the recording method and the reproducing method in various fashions. For example, it is possible for the signal light 4 and the reference light 5 to be incident on the recording medium 1 from different surfaces.

Where the data is recorded in the form of digital data, it is possible to construct the data storage apparatus such that a single datum is represented by a multiplicity of pixels of the image display device 15.

Also, where the data is given by the intensity distribution of the signal light, it is possible for the light intensities in the bright portion and the dark portion not to be uniform over the entire beam diameter. For example, it is possible for the transmittance of light in the image display element to be made low in the central portion and to be made high in the portion remote from the center. In this case, it is possible to correct in advance the situation that the reproduced light is more weakened in a portion remote from the center than in the central portion of the reproduced signal. Alternatively, it is also possible to arrange in front of the reading device 18 a spatially light modulator that permits the absorption coefficient to be made large in the central portion and to be made small in a portion remote from the center so as to obtain a similar effect.

The recording medium and apparatus of the embodiment of the present invention can also be used in the case where similar holographic recording is performed by using the recording medium having a reflection layer formed on one surface in place of the recording medium of the transmission type described above. In this case, it is possible to allow the recording light and the data light to be incident coaxially on the recording medium. Since the reflected light is detected as the reproduced light, the apparatus of this type differs from the apparatus of the transmission type in that it is desirable for the light detector and the laser used as a light source to be positioned on the same side as the recording medium.

The recording medium of the present invention is not limited to the examples given above. It is possible to modify the recording medium of the present invention in various fashions within the technical scope of the present invention.

For example, it is possible for the recording medium according to one embodiment of the present invention to perform the data storage in a multiplex mode. The multiplex recording will now be described.

In the holographic memory, a signal light containing the recording data is superposed within the recording medium with a reference light capable of interference with the signal light so as to generate an interference fringe, and the data is recorded by recording the interference fringe, as already described. The k-vector of the interference fringe extends in a direction perpendicular to the perpendicular bisector between the running direction of the object light and the running direction of the reference light. In other words, the bright portion and the dark portion of the interference fringe formed within the recording medium are contiguous in the direction of the perpendicular bisector. The internal electric field is formed within the recording layer in a direction perpendicular to the fluctuation in the intensity of the light. A refractive index modulated grating is recorded in the recording medium, if a reference light is allowed to be incident on the recording medium at an angle equal to that in the recording stage. The light diffracted by the refractive index modulated grating thus recorded in the recording medium has a component of the object light. The data is reproduced by reading the object light noted above. Where the incident angle of the reference light differs, the Bragg condition is not satisfied and, thus, the object light is not reproduced. Where the angle of the k-vector of the interference fringe is changed, the internal electric field is also generated in the direction in which the direction of the k-vector is changed. The internal electric field at an optional point within the recording medium is equal to the sum of the recorded electric field vectors.

In other words, it is possible to perform the multiplex recording in the same site by changing the incident angle of the signal light and/or the reference light incident on the recording medium.

Generally speaking, the incident angle of the signal light and/or the reference light on the recording medium can be changed by (1) the method of changing the incident angle while retaining the angle made between the object light and the reference light, and (2) the method of changing the angle made between the object light and the reference light. Also, the angle can be changed by, for example, (3) the method of rotating the sample, and (4) the method of changing the running direction of the light beam.

The running direction of the light beam can be changed by, for example, the method of irradiating an optical part such as a prism or a mirror while rotating the optical part, the method of changing the running direction of the transmitted light or the reflected light by utilizing the magnetooptical effects such as the Kerr effect and the Pockels effect or by utilizing the electrochemical effect, the method of changing the diffracting direction by displaying a diffraction grating on a liquid crystal display device and changing the lattice width, and the method of allowing a reference light and an object light to pass through the recording medium performing the self-focusing (three dimensional nonlinear optical characteristics) function in which the focal length is changed by the light intensity so as to change the angle made between the reference light and the object light.

Such being the situation, it is possible to employ an optional combination of at least two of methods (1) to (4) given above in the actual apparatus. Some combinations will now be exemplified for describing in detail the practical method of changing the running direction of the light beam.

Where method (1) is combined with method (3), the recording medium is fixed to, for example, a rotatable table, and the table is rotated. Where method (1) is combined with method (4), a mirror for guiding the object light and the reference light to the recording medium, the diffraction grating, the lens, etc. are rotated simultaneously so as to make constant the angle between the object light and the reference light on the recording medium. Where method (2) is combined with method (3) (in this case, method (4) is also combined), the lens for guiding the object light and the reference light to the recording medium is formed of an acoustic optical effect element, and the sample is also rotated while moving the lens by changing the focal length of the lens. Further, where method (2) is combined with method (4), the mirror for guiding the object light and the reference light to the recording medium, the diffraction grating, the lens, etc. are freely rotated simultaneously, or only one of these mirror, diffraction grating and lens is freely rotated.

In the case of employing any of these combinations, it is possible to perform a multiplex recording of the data in the recording layer included in the recording medium according to the embodiment of the present invention so as to reproduce the desired data.

The present invention will now be described more in detail with reference to some Examples of the present invention.

### EXAMPLE 1

In the first step, a recording medium was prepared as follows.

Specifically, a solution was prepared by dissolving in toluene 40% by weight of N,N′-diphenyl-N,N′-(2-naphthyl)-(1,1′-phenyl)-4,4″-diamine used as a charge transport material, 35% by weight of N-[[4-(dimethylamino)phenyl]-methylene]-2-methyl-4-nitrobenzene amine (DBMNA) performing the functions of the nonlinear optical material and the trapping material, 5% by weight of diaryl ethene compound represented by chemical formulas given below and used as an optical functional molecule, and 20% by weight of Arton (trade name of a polymer manufactured by Nippon Synthetic Rubber K.K.) used as a matrix polymer:

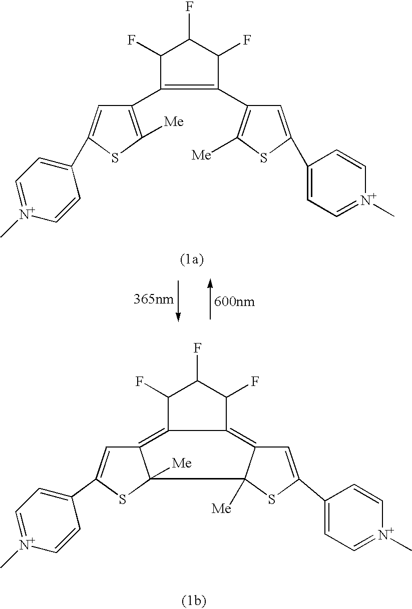

Two glass substrates were prepared, and an ITO (Indium Tin Oxide) film was formed on the surface of one of these glass substrates, and a translucent Au electrode was formed on the surface of the other glass substrate. These glass substrates having the ITO film and the Au electrode formed on the surfaces thereof can be called a substrate provided with an ohmic electrode.

The substrate was coated by a casting method with the toluene solution referred to above so as to form a recording layer. After the solvent was removed sufficiently, an another substrate was pushed from above against the substrate having the recording layer formed thereon while irradiating the substrate having the recording layer formed thereon with an ultraviolet light under the state that the substrate having the recording layer formed thereon was heated to 120° C., thereby obtaining a recording medium. The thickness of the recording medium was adjusted at 100 μm by using a spacer made of Teflon (registered trade mark).

As shown in the chemical formulas given above, the diaryl ethene compound used as an optical functional compound in this Example assumes two structures depending on the wavelength of irradiating light. To be more specific, where the compound is irradiated with an ultraviolet light having a wavelength of 365 nm, the central ring is closed as shown in formula (1b). The compound assuming this structure has an ionization potential of 5.7 eV. On the other hand, where the compound is irradiated with a visible light having a wavelength of 600 nm, the central ring is opened as shown in formula (1a). It is reported that, under the structure shown in formula (1a), the ionization potential of the compound is increased to a level not lower than 6.2 eV. In other words, the ionization potential of the diaryl ethene compound is rendered deeper by the irradiation with an ultraviolet light, and is rendered shallower by the irradiation with a visible light.

In this Example, the recording layer was irradiated with an ultraviolet light during manufacture of the recording medium and, thus, many diaryl ethene compounds (or molecules) assume the structure shown in formula (1b).

The recording medium thus obtained was put under a dark environment, and a voltage of 300V was applied between the upper and lower electrodes, with the result that a current of 200 pA/cm² was found to flow through the recording medium. In this case, the applied electric field was 3×10⁴ V/cm and, thus, the conductivity was 6.7×10⁻¹⁵ S/cm. Where the recording medium was irradiated with light having a wavelength of 632.8 nm and an intensity of 0.1 mW/cm², the current that was caused to flow through the recording medium by the application of a voltage of 300V was lowered to 10 pA/cm². In this case, the conductivity is 3.3×10⁻¹⁶ S/cm.

A hologram was recorded in and reproduced from the recording medium by using a recording apparatus constructed as shown in FIG. 2. As shown in the drawing, the light emitted from a He-Ne laser 9 (wavelength of 632.8 nm and an output of 30 mW) was divided first by the beam splitter 12 into two parts. The diameter of the light beam reflected from the beam splitter 12 was expanded by using a beam expander 11 and, then, allowed to run through the liquid crystal image display element 15. The transmittance of the liquid crystal image display element 15 was modulated in advance in accordance with the data that was to be recorded. The light transmitted through the liquid crystal image display element 15 formed the signal light 4. The signal light 4 was converged by using the lens 16 having a focal length of 150 nm. The distance between the lens 16 and the recording medium 1 was set at 135 nm.

On the other hand, the recording medium 1 was irradiated with the light transmitted through the beam splitter 12 and used as the reference light 5. In this case, the optical path of the reference light 5 was adjusted by, for example, a beam expander 10 so as to permit the reference light 5 to cover the region on which the signal light 4 was converged on the recording medium 1. The incident angles of the signal light 4 and the reference light 5 on the recording medium 1 were measured outside the recording medium 1. The incident angles of the signal light 4 and the reference light 5 were found to be 40° and 50°, respectively, relative to a line normal to the recording medium 1.

The electrodes 3a and 3b of the recording medium 1 were connected to the external power source 7 so as to permit a constant current to flow through the recording medium 1. In other words, charge was injected into the recording medium 1. Under this condition, the recording medium 1 was irradiated with light for 5 ms so as to record data in the recording medium 1 as hologram.

In the next step, the recorded data was reproduced. In reproducing the recorded data, the optical path of the signal light 4 was cut by a shutter, and the recording medium 1 was irradiated with the light transmitted through the beam splitter 12 and used as the reading light, with the result that a diffracted light was observed. When the diffracted light, which was transmitted through the lens 17 (focal length of 150 nm) similar to the lens 16, was allowed to be incident on a CCD used as the reading device 18, detected was a reproduced light having an intensity distribution similar to that of the signal light 4.

The diffraction efficiency immediately after the recording was found to be 1.0% and to be 0.9% even 6 months later. Also, the optical quality of the recording medium such as the fluctuation of the transmittance inside the recording medium was left unchanged even 6 months later.

In the next stage, the output from the liquid crystal image display element 15 was recorded at the same site on 100 paper sheets by the angular multiplex recording mode. It was possible to reproduce the image from any page of the paper sheets. Also, the image recorded by the multiplex recording mode was found to be capable of reproduction even 6 months later.

### Comparative Example 1

The conventional photorefractive polymer recording medium was manufactured by the method similar to that in Example 1, except that the diaryl ethene compound used as an optical functional molecule was not added in preparing the toluene solution, and that 4.7% by weight of Arton used as a polymer matrix and 0.3% by weight of C₇₀ used as a charge generating material were added in place of the diaryl ethene compound in preparing the toluene solution.

Various experiments were conducted for the resultant recording medium under the conditions equal to those in Example 1. The diffraction efficiency substantially equal to that for Example 1 was not obtained even if the recording was performed for 10 s. Also, the conductivity was increased from 8.5×10⁻¹⁵ S/cm to 7.2×10⁻¹⁴ S/cm. It follows that, where the recording layer does not contain an optical functional molecule, the probability for the carrier to be trapped is low, leading to a very low efficiency of the data storage.

### EXAMPLE 2

A recording medium was prepared as follows.

Specifically, a solution was prepared by dissolving in toluene 35% by weight of diaryl ethene compound represented by chemical formulas given below and used as a charge transport material and as an optical functional molecule, 35% by weight of N-[[4-(dimethylamino)phenyl]-methylene]-2-methyl-4-nitrobenzene amine (DBMNA) performing the functions of the nonlinear optical material and the trapping material, 30% by weight of Zeonex 480R manufactured by Nippon Zeon K.K. and used as a matrix polymer:

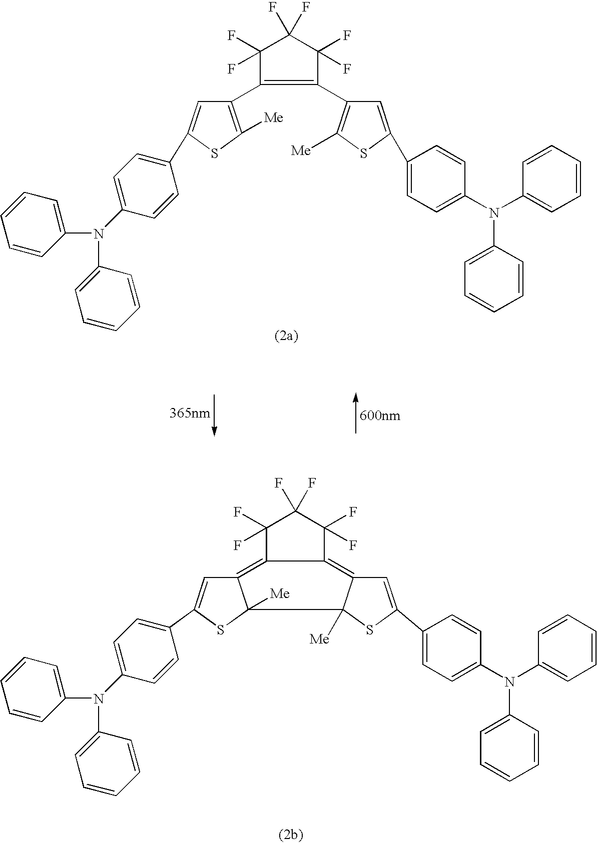

A recording medium was prepared as in Example 1 by using the toluene solution thus prepared.

As shown in the chemical formulas given above, the diaryl ethene compound used as an optical functional compound in this Example assumes two structures depending on the wavelength of irradiating light. To be more specific, where the compound is irradiated with an ultraviolet light having a wavelength of 365 nm, the central ring is closed as shown in formula (2b). The compound assuming this structure has an ionization potential of about 5.4 eV. On the other hand, where the compound is irradiated with a visible light having a wavelength of 600 nm, the central ring is opened as shown in formula (2a). It is reported that, under the structure shown in formula (2a), the ionization potential of the compound is increased to about 5.8 eV. In other words, the ionization potential of the diaryl ethene compound is rendered greater by the irradiation with an ultraviolet light, and is rendered smaller by the irradiation with a visible light.

In this Example, the recording layer was irradiated with an ultraviolet light during manufacture of the recording medium and, thus, many diaryl ethene compounds (or molecules) assume the structure shown in formula (2b).

The recording medium thus obtained was evaluated under the conditions similar to those for Example 1, except that a laser having an oscillation wavelength of 405 nm was used as the light source 9. As a result, the diffraction efficiency reached 3.0% at the response time of 20 ms so as to make it possible to record a hologram in the recording medium. In this case, the conductivity was lowered by the light irradiation from 5.5×10⁻¹⁵ S/cm to 2.2×10⁻¹⁵ S/cm.

The diffraction efficiency even 6 months later was found to be 1.4%. Also, the optical quality of the recording medium was left unchanged even 6 months later.

In the next stage, the output from the liquid crystal image display element 15 was recorded at the same site on 100 paper sheets by the angular multiplex recording mode. It was possible to reproduce the image from any page of the paper sheets. Also, the image recorded by the multiplex recording mode was found to be capable of reproduction even 6 months later.

### EXAMPLE 3

A recording medium was prepared as follows.

Specifically, a solution was prepared by dissolving in toluene 30% by weight of 1,1′-bis(p-diethylamino phenyl)-4,4-diphenyl-1,3-butadiene used as a charge transport material, 30% by weight of N-[[4-(dimethylamino)phenyl]-methylene]-2-methyl-4-nitrobenzene amine (DBMNA) performing the functions of the nonlinear optical material and the trapping material, 20% by weight of spiro pyran compound represented by chemical formulas given below and used as an optical functional molecule, and 20% by weight of Arton (trade name of a polymer manufactured by Nippon Synthetic Rubber K.K.) used as a matrix polymer:

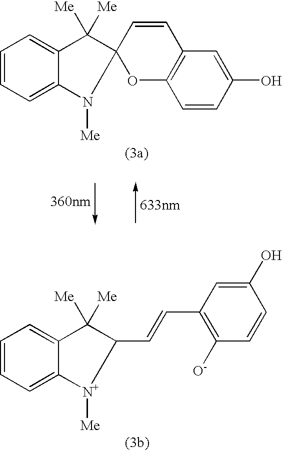

A recording medium was prepared as in Example 1 by using the resultant toluene solution.

As shown in the chemical formulas given above, the spiro pyran compound used as an optical functional compound in this Example assumes two structures depending on the wavelength of irradiating light. To be more specific, where the compound is irradiated with an ultraviolet light having a wavelength of 360 nm, the compound assumes the structure shown in formula (3b). On the other hand, where the compound is irradiated with a visible light having a wavelength of 633 nm, the compound assumes the structure shown in formula (3a). It should be noted that the dipole of the recording layer is increased by the irradiation with an ultraviolet light so as to permit the recording layer to have an absorption in the visible light region. In this Example, the recording layer was irradiated with an ultraviolet light during manufacture of the recording medium and, thus, many spiro pyran compounds (or molecules) assume the structure shown in formula (3b). It should also be noted that the structure shown in formula (3a) differs from the structure shown in formula (3b) in the mobility. To be more specific, where many optical functional molecules assume the structure shown in formula (3b), the mobility is decreased, compared with the case where many optical functional molecules assume the structure shown in formula (3a).

The recording medium thus obtained, which had a thickness of 150 μm, was put under a dark environment, and a voltage of 500V was applied between the upper and lower electrodes, with the result that a current of 450 pA/cm² was found to flow through the recording medium. In this case, the conductivity was 1.35×10⁻¹⁴ S/cm. Where the recording medium was irradiated with light having a wavelength of 400 nm and an intensity of 100 mW/cm², the current that was caused to flow through the recording medium by the application of a voltage of 500V was lowered to 200 pA/cm². In this case, the conductivity is 6.0×10⁻¹⁵ S/cm.

Also, the mobility was measured separately. The mobility, which was about 2×10⁻⁶ cm²/Vs before the light irradiation, was lowered to about 4×10⁻⁷ cm²/Vs after the light irradiation.

In the next step, a hologram was recorded in and reproduced from the recording medium by using a recording apparatus constructed as shown in FIG. 2. The incident angles of the signal light 4 and the reference light 5 were measured outside the recording medium 1 and found to be 40° and 50°, respectively, relative to a line normal to the recording medium 1.

The electrodes 3a and 3b of the recording medium 1 were connected to the external power source 7 so as to permit a constant current to flow through the recording medium 1. In other words, charge was injected into the recording medium 1. Under this condition, the recording medium 1 was irradiated with light for 5 ms so as to record data in the recording medium 1 as a hologram.

Then, the recorded data was reproduced by the method similar to that in Example 1. Detected was a reproduced light having an intensity distribution similar to that of the signal light 4.

The diffraction efficiency immediately after the recording was found to be 0.5% and to be 0.4% even 6 months later. Also, the optical quality of the recording medium was left unchanged even 6 months later.

In the next stage, the output from the liquid crystal image display element 15 was recorded at the same site on 100 paper sheets by the angular multiplex recording mode. It was possible to reproduce the image from any page of the paper sheets. Also, the image recorded by the multiplex recording mode was found to be capable of reproduction even 6 months later.

### Comparative Example 2

The conventional photorefractive polymer recording medium was manufactured by the method similar to that in Example 3, except that the Spiro pyran compound used as an optical functional molecule was not added in preparing the toluene solution, and that 19.7% by weight of Arton used as a polymer matrix and 0.3% by weight of C₇₀ used as a charge generating material were added in place of the spiro pyran compound in preparing the toluene solution.

Various experiments were conducted for the resultant recording medium under the conditions equal to those in Example 3. The diffraction efficiency substantially equal to that for Example 3 was not obtained even if the recording was performed for 100 s. The mobility after the light irradiation was found to be equal to that before the light irradiation, and the conductivity was increased by the light irradiation. Also, the recording was performed on only three paper sheets in the case of employing the angular multiplex recording mode.

### EXAMPLE 4

A recording medium was prepared as follows.

Specifically, a solution was prepared by dissolving in toluene 25% by weight of 4-N,N-bis(4-methylphenyl)amino-α-phenyl stilbene used as a charge transport material, 30% by weight of 1,3-dimethyl-2,2-tetramethyl-5-nitrobenzimidazoline performing the function of the nonlinear optical material, 5% by weight of triphenyl amine used as a trapping material, 20% by weight of spiro pyran compound represented by chemical formulas given below and used as an optical functional molecule, and 20% by weight of polyarylate manufactured by Unitica K.K. and used as a matrix polymer:

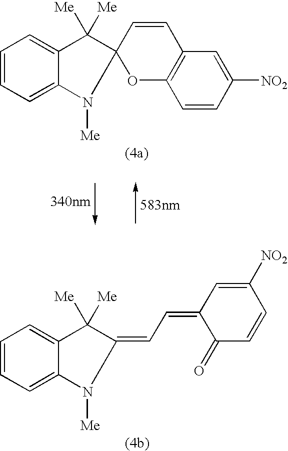

A recording medium was prepared as in Example 1 by using the resultant toluene solution, except that the heating temperature was changed to 140° C. and the thickness of the recording medium was set at 200 μm.

As shown in the chemical formulas given above, the spiro pyran compound used as an optical functional compound in this Example assumes two structures depending on the wavelength of irradiating light. It should be noted that the dipole is increased by the irradiation with blue to green light beams. As a result, the carrier concentration is increased in the portion irradiated with the light, with the result that the charge injected from the electrode is trapped by the trapping material in the portion irradiated with the light. In this Example, the recording layer was irradiated with an ultraviolet light during manufacture of the recording medium. As a result, many spiro pyran compounds used as the optical functional molecules are under the state shown in formula (4b). Also, the structure shown in formula (4a) differs from the structure shown in formula (4b) in the mobility. To be more specific, the structure shown in formula (4b) has a dipole larger than that of the structure shown in formula (4a). It follows that the mobility in the case where many optical functional molecules assume the construction of formula (4b) is rendered lower than that in the case where many optical functional molecules assume the construction of formula (4a). When calculated by the molecular orbital method, the mobility was found to have been increased by about 0.5 debye.

The mobility of the recording medium was measured first. The mobility before the light irradiation, which was about 5×10⁻⁷ cm²/Vs, was found to have been decreased to about 2×10⁻⁷ cm²/Vs after the light irradiation. The conductivity was also decreased by the light irradiation.

A digital data was recorded as bits by converging a light beam on the recording medium. To be more specific, data was recorded in the form of three dimensional bits by allowing a semiconductor laser having a wavelength of 405 nm and an output of 3 mW to emit light, and by converging the emitted light within the recording medium. It was possible to record the bit in 0.2 μs. Also, it has been confirmed that it is possible to hold the recording even one year later.

### Comparative Example 3

The conventional photorefractive polymer recording medium was manufactured by the method similar to that in Example 4, except that the spiro pyran compound used as an optical functional molecule was not added in preparing the toluene solution, and that 19.7% by weight of polyarylate used as a polymer matrix and 0.3% by weight of C₇₀ used as a charge generating material were added in place of the spiro pyran compound in preparing the toluene solution.

The mobility after the light irradiation was found to be equal to that before the light irradiation, and the conductivity was increased by the light irradiation.

Various experiments were conducted for the resultant recording medium under the conditions equal to those in Example 4. The recording of the bit was found to require 10 ms.

As described above, the present invention provides a data storage medium capable of a high speed recording with a high capacity and a data storage apparatus for recording data in the particular recording medium.

The present invention is effective for realizing a high density recording and, thus, has a prominent industrial value.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data storage medium, comprising:
a recording layer containing molecules having a charge transport characteristics, molecules having a nonlinear optical characteristics, and optical functional molecules whose stereostructure is changed depending on a light irradiation; and
a pair of transparent ohmic electrodes sandwiching the recording layer, the conductivity of the data storage medium being lowered by the light irradiation.

2. The data storage medium according to claim 1, wherein an ionization potential, a permanent dipole moment or a mobility is changed by the change in the stereostructure of the optical functional molecule.

3. The data storage medium according to claim 2, wherein the permanent dipole moment is increased by at least 0.7 debye by the change in the stereostructure of the optical functional molecule.

4. The data storage medium according to claim 2, wherein the ionization potential is changed by at least 0.01 eV by the change in the stereostructure of the optical functional molecule.

5. The data storage medium according to claim 2, wherein the mobility is lowered by the change in the stereostructure of the optical functional molecule to 0.5 or less times as much as the value of mobility before the change in the stereostructure of the optical functional molecule.

6. The data storage medium according to claim 1, wherein the optical functional molecule is at least one compound selected from the group consisting of spiro pyrans, spiro oxazines, fulgides, cyclophenes, diaryl ethene series compounds, chalcon derivatives, azo benzene series compounds, polyacrylate or polysiloxane having a cyano biphenyl group, which is prepared by allowing a high molecular weight liquid crystal material to contain a photochromic molecule, and polysiloxane having a spiro benzofuran group.

7. The data storage medium according to claim 1, wherein the recording layer further contains a trapping material.

8. The data storage medium according to claim 1, wherein the ohmic electrode is formed of ITO, Au, Al or Mg.

9. The data storage medium according to claim 1, further comprising a transparent substrate formed on one of the ohmic electrodes.

10. The data storage medium according to claim 1, wherein a poling treatment is applied in the recording layer of the data storage medium.

11. A data storage apparatus, comprising:
a data storage medium including a recording layer containing molecules having a charge transport characteristics, molecules having a nonlinear optical characteristics, and optical functional molecules whose stereostructure is changed according to light beam irradiation, and a pair of transparent ohmic electrodes sandwiching the recording layer, the conductivity of the data storage medium being lowered by the light beam irradiation;
a power source applying an electric field between the pair of transparent ohmic electrodes of the data storage medium;
a light source irradiating the data storage medium with the light beam;
a beam splitter dividing the light beam into two sections;
a spatial light modulator adding a data to be recorded to one of the divided light sections; and
an optical architecture allowing the divided two light sections to cross each other within the data storage medium forming an interference fringe in the recording layer of the data storage medium so as to write data.

12. The data storage apparatus according to claim 11, wherein an ionization potential, a permanent dipole moment or a mobility is changed by the change in the stereostructure of the optical functional molecule.

13. The data storage apparatus according to claim 12, wherein the permanent dipole moment is increased by at least 0.7 debye by the change in the stereostructure of the optical functional molecule.

14. The data storage apparatus according to claim 12, wherein the ionization potential is changed by at least 0.01 eV by the change in the stereostructure of the optical functional molecule.

15. The data storage medium according to claim 12, wherein the mobility is lowered by the change in the stereostructure of the optical functional molecule to 0.5 or less times as much as the value of mobility before the change in the stereostructure of the optical functional molecule.

16. The data storage medium according to claim 11, wherein the optical functional molecule is at least one compound selected from the group consisting of spiro pyrans, spiro oxazines, fulgides, cyclophenes, diaryl ethene series compounds, chalcon derivatives, azo benzene series compounds, polyacrylate or polysiloxane having a cyano biphenyl group, which is prepared by allowing a high molecular weight liquid crystal material to contain a photochromic molecule, and polysiloxane having a spiro benzofuran group.

17. The data storage medium according to claim 11, wherein the recording layer further contains a trapping material.

18. The data storage medium according to claim 11, wherein the ohmic electrode is formed of ITO, Au, Al or Mg.

19. The data storage medium according to claim 11, further comprising a transparent substrate formed on one of the ohmic electrodes.

20. The data storage medium according to claim 11, wherein a poling treatment is applied in the recording layer of the data storage medium.
